(19) United States
(12) Patent Application Publication
(10) Pub. No.: US 2009/0159261 A1
(43) Pub. Date: Jun. 25, 2009

(54) Bird Bath Wellhead Cover

(76) Inventors: Martin G. Lira, Lake Mills, WI (US); Linda A. Lira, Lake Mills, WI (US); Jeffrey S. Nachreiner, Lake Mills, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/963,332

(22) Filed: Dec. 21, 2007

(51) Int. Cl. E21B 33/03; A01K 45/00

(52) U.S. Cl. 166/75.13; 119/69.5

(57) ABSTRACT

A device comprised of a basin forming a reservoir and a lip extending downward from the bottom surface of the basin and adapted to temporarily secure the device to a wellhead such that the device at least partly conceals the wellhead. In one embodiment, the device is a bird bath.

### FIELD OF THE INVENTION

This invention relates generally to the field of bird baths, and in particular to a bird bath that is supported by a wellhead to provide an aesthetically pleasing appearance to the wellhead.

### BACKGROUND

Many Americans use groundwater. For those that do, the proper protection of the well and wellhead is essential for the health of the users. Groundwater is susceptible to contamination from a variety of sources, including septic tanks, pesticides, and household chemicals. As hundreds of wells often tap into the same aquifer, it is essential to prevent contamination from reaching the aquifer. Proper use and maintenance of a wellhead can minimize the risk of drinking water becoming polluted. Ideally, the well and wellhead should sit high in the landscape so surface water drains away from it and be one to two feet tall to prevent flooding from contaminating the groundwater.

Unfortunately, the existence of the wellhead can be conspicuous and detract from the natural beauty of the immediate area. What is needed is a way to make use of the wellhead to create an aesthetically pleasing area and/or at least partially conceal the wellhead.

As used herein, in the terms “wellhead” and “well cap” refer to that part of a well that terminates or protrudes at or above the ground level and is attached to the opening of the water well, i.e., the well casement. Wellheads are generally cylindrically shaped, but the bird bath wellhead cover can be adapted for use with any shape wellhead cover.

As used herein, the term “basin” refers to a receptacle which may be adapted water or solid material including water, birdseed, sand, pebbles, plants, animal food products and salt blocks or any other material capable of being stored in a receptacle.

As used herein, the term “adaptation feature” refers a feature of the device that is calculated to adapt to a wellhead configuration and may or may not have the effect of varying the basin depth to facilitate use of birds of varying sizes and species. For example, an adaptation feature may accommodate the size of and shape of the cap on a well, neck of a pipe, or other structure.

As used herein, the term “water depth regulator” refers a feature of the device which is calculated allow excess water to drain from the basin portion, and may be a hole, a slit, a slope, a grate, a screen or any other component adapted to regulate the level of water with the basin portion of the device and/or promote drainage.

### SUMMARY OF THE INVENTION

The present invention is a device comprised of: a basin forming a reservoir and having a lower surface, and a lip extending downward from the bottom surface of the basin, in which the lip is adapted to temporarily secure the device to a wellhead to at least partly conceals the wellhead. The device can be a bird feeder or adapted to hold bird seed and/or flora, can be cir circular, ovular, elliptical, or rectangular, can further include ornamentation, and can be made from metal, wood, plastic, and combinations thereof. The basin and lip can be separate pieces or integrally formed. In one embodiment, the lip includes an inner portion, an outer portion, at least one aperture, and at least one screw corresponding to one of the apertures, such that each screw laterally translates to frictionally engage the wellhead. The device can further include an adaptation feature to provide a more shallow area and/or at least one water depth regulator to prevent the device from over-filling.

### BRIEF DESCRIPTION OF THE DRAWINGS

FIG. 1 shows a side view of one embodiment of the bird bath wellhead cover positioned immediately above a wellhead.

FIG. 2 shows a top view of the embodiment of the bird bath wellhead cover shown in FIG. 1.

FIG. 3 shows a top perspective view of the embodiment of the bird bath wellhead cover shown in FIG. 1.

FIG. 4 shows a bottom view of the embodiment of the bird bath wellhead cover shown in FIG. 1, in which the lip can be viewed.

FIG. 5 shows a bottom perspective view of the embodiment of the bird bath wellhead cover shown in FIG. 1, in which the lip can be viewed.

FIG. 6 shows a bottom perspective view of an alternate embodiment of the bird bath wellhead cover that does not include an adaptation feature or a water depth regulator.

### DETAILED DESCRIPTION OF EMBODIMENTS OF THE INVENTION

For the purpose of promoting an understanding of the present invention, references are made in the text hereof to embodiments of a bird bath wellhead cover, only some of which are described herein. It should nevertheless be understood that no limitations on the scope of the invention are thereby intended. One of ordinary skill in the art will readily appreciate that modifications such as the dimensions of the bird bath wellhead cover, alternate but functionally similar material(s) from which the bird bath wellhead cover is made, and the inclusion of additional elements are deemed readily apparent and obvious to one of ordinary skill in the art, and all equivalent relationships to those described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near indentical structural elements.

Moreover, the term “substantially” or “approximately” as used herein may be applied to modify any quantitative representation that could permissibly vary without resulting in a change in the basic function to which it is related. For example, one embodiment of the bird bath wellhead cover is disclosed herein as having an eliptical shape. The bird bath wellhead cover may be of any alternate shape and still be within the scope of the invention if its functionality is not materially altered.

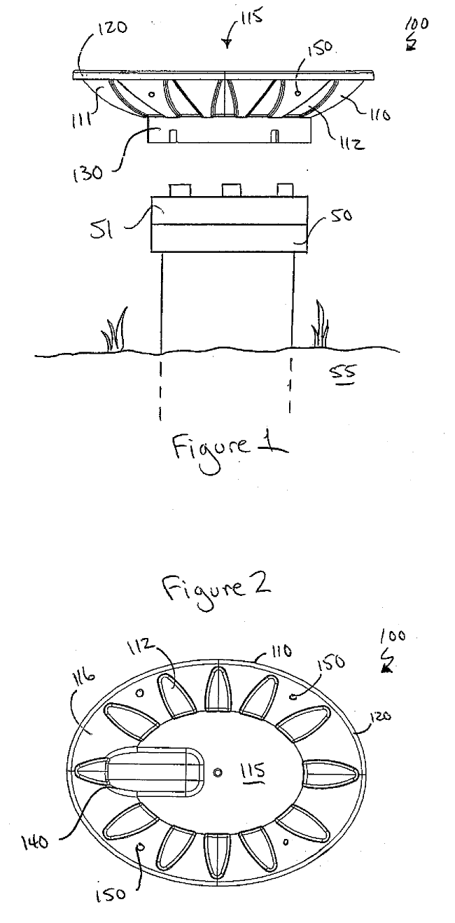

Referring now to the drawings, FIG. 1 shows a side view of one (1) embodiment of bird bath wellhead cover 100 positioned immediately above wellhead 50. As can be appreciated, wellhead 50 extends from ground 55, and bird bath wellhead cover 100 is sized to fit over wellhead 50. In the embodiment shown, wellhead 50 is cylindrically shaped and bird bath wellhead cover 100 is similarly shaped, but wellhead 50 can be any alternate shape and bird bath wellhead cover 100 can be adapted and similarly shaped to allow bird bath wellhead cover 100 to fit over wellhead 50.

Bird bath wellhead cover 100 is comprised of basin 110, edge 120, and lip 130. Basin 110 is generally rounded and arcuate, i.e., bowl shaped, and forms water reservoir 115. Water reservoir 115 can capture and hold water for use by birds as a bird bath. It should be understood that basin 110 can be of any shape, can be deep or shallow, can have a deep portion and a shallow portion, and outer surface 111 can include ornamentation 112 (such as the texture shown), or be smooth. That is, the invention should not be limited to any particular shape of bird bath wellhead cover 100 or basin 110. In addition, the embodiment shown in FIG. 1 is specifically adapted to hold water within water reservoir 115, it should be understood that bird bath wellhead cover 100 can alternately be adapted to hold bird seed, flora, or any other aesthetically or functional object(s), in which case water reservoir 115 would be identified as a seed reservoir, flora reservoir, etc.

In the embodiment shown, basin 110 is injection molded and made of plastic, but can be made of any structurally sound and durable material commonly known and used in the art, including metal, wood, concrete, and combinations thereof. Basin 110 can also be treated to withstand sunlight and other outdoor conditions. In addition, basin 110 is colored to provide a pleasant appearance. In the embodiment shown, basin 110 is green, but can be colored tan, grey, or any additional color or multiple colors or patterns, and can be shiny or matte. In addition, basin 110 can be constructed of a material that can be colored by the end user. For example, basin 110 can be made of plastic and be sold with or come with instructions that instruct a purchaser or user to spray paint basin 110 any desired color(s).

In the embodiment shown, basin 110 has a length of 24.05 inches, a width of 18.05 inches, and a height of 5.74 inches, with the height of rib 130 being 2.06 inches. However, as included herein, the invention should not be limited to any particular dimensions of bird bath wellhead cover 100 or any of its components.

Also visible in FIG. 1 is edge 120. Edge 120 provides a perch for the birds to enter bird bath wellhead cover 100, but is not an essential element. For aesthetic or functional purposes, edge can be eliminated such that basin 110 simply forms an upper edge, whether squared, rounded, pointed, or of another shape.

Also visible in FIG. 1 are four (4) water depth regulators 150. Water depth regulators 150 allow water within basin 110 to only get to a certain depth, above which, water will flow through water depth regulators 150. Water depth regulators 150 can be at any height along basin 110 to maintain the water's depth at any level. It should be noted that water depth regulators 150 are positioned outward of lip 130 and therefore also outward of wellhead 50 to prevent the overflow water from potentially entering wellhead 50 and potentially contaminating the groundwater to which wellhead 50 provides access.

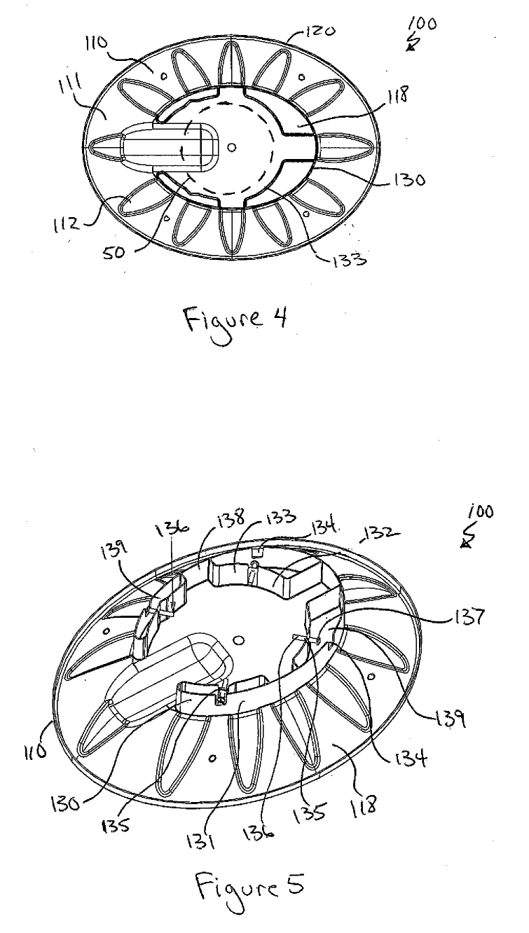

Also visible in the embodiment of bird bath wellhead cover 100 shown in FIG. 1 is lip 130. Lip 130 extends downward from basin 110. As will be discussed in greater detail infra with respect to FIGS. 3 and 4, lip 130 is sized to fit over wellhead 50 such that bird bath wellhead cover 100 can be temporarily secured to wellhead 50.

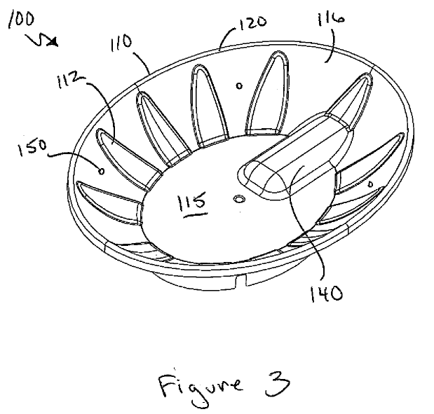

FIG. 2 shows a top view of the embodiment of bird bath wellhead cover 100 shown in FIG. 1. As can be seen, basin 110 and edge 120 are generally elliptically shaped. However, it should be understood that the present invention should not be limited to any particular shape of basin 110, which can also be rectangular, circular, ovular, or any other regular or irregular shape. In addition, the embodiment of inner surface 116 further includes ornamentation 112, but as with the ornamentation on the outer surface (not visible), inner surface 116 is not limited to any particular type of ornamentation 112 or can be smooth.

FIG. 3 shows a top perspective view of the embodiment of bird bath wellhead cover 100 shown in FIG. 1. Specifically, adaptation feature 140 can be seen. Adaptation feature 140 provides a shallower area within water reservoir 115 of basin 110, thus providing safe access to the water (for those embodiments of bird bath wellhead cover 100 used as a bird bath) for smaller birds. Adaptation feature 140 can be integrally molded with basin 110 or can be a separate piece. In addition, adaptation feature 140 can be made of the same material as basin 110 or another material.

FIG. 4 shows a bottom view of the embodiment of the bird bath wellhead cover shown in FIG. 1. As can be seen, basin 110 includes bottom surface 118 and bird bath wellhead cover 100 includes lip 130 extending (downward when on top of the wellhead) from bottom surface 118. Lip 130 is generally the same shape as basin 110, but further includes generally circular portion 133 that is sized to be substantially the same shape as and slightly larger than wellhead 50 (shown in dashed lines). As will be discussed in detail with respect to FIG. 4, lip 130 allows bird bath wellhead cover 100 to be temporarily secured to wellhead 50.

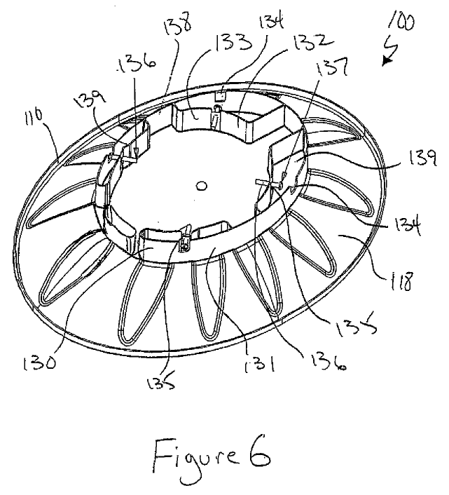

FIG. 5 shows a bottom perspective view of the embodiment of bird bath wellhead cover 100 shown in FIG. 1. In the embodiment shown, lip 130 is attached to bottom surface 118 of basin 110, but lip 130 and basin 110 can be integrally formed of a single piece. Lip 130 is comprised of an outer surface 131 and an inner surface 132 that forms circular portion 133. Inner surface 132 is slightly larger and generally the same shape as the wellhead (not shown) so that bird bath wellhead cover 100 fits over the top of the wellhead without too much room between the wellhead's outer surface (see element number 51 of FIG. 1) and inner surface 132 of lip 130. Portion 133 further includes several apertures 135, through which a corresponding screw 136 is positioned. In the embodiment of bird bath wellhead cover 100 shown in FIG. 4, portion 133 includes four (4) apertures 135 and four (4) corresponding screws 136, and each screw 136 has a clip on nut 137 disposed thereon. Each screw 136 is turned to laterally translate screw 136 inward of portion 133 until it abuts and snugly secures bird bath wellhead cover 100 to the outer surface of the wellhead. Access points 134 allow a user to access screws 136. Bird bath wellhead cover 100 is thus temporarily secured to the wellhead, allowing it to be removed to allow access to the wellhead.

Also visible in FIG. 5 are gaps 138 and spaces 139. Gaps 138 are positioned between sections of portion 133 and spaces 139 exist between inner surface 132 and outer surface 131 of lip 130 to reduce weight. In alternate embodiments, lip 130 can be more or less solid than the embodiment shown, depending on the use of bird bath wellhead cover 100.

FIG. 6 shows a bottom perspective view of an alternate embodiment of the bird bath wellhead cover 100 that does not include an adaptation feature or any water depth regulators. Alternate embodiments can include one (1) of adaptation feature or depth regulator(s). Such an embodiment of bird bath wellhead cover 100 is also applicable to an embodiment in which the adaptation feature is not integrally formed with basin 110.

While the bird bath wellhead cover has been shown and described with respect to several embodiments and uses in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. A device comprised of:
a basin, said basin forming a reservoir and having a lower surface; and
a lip extending downward from said bottom surface of said basin, said lip adapted to temporarily secure said device to a wellhead;
wherein said device at least partly conceals said wellhead.

2. The device of claim 1, wherein said basin is formed of a shape selected from a group consisting of circular, ovular, elliptical, and rectangular.

3. The device of claim 1, wherein said reservoir is adapted to hold a substance selected from a group consisting of water, bird seed, and flora.

4. The device of claim 1, wherein said basin further includes ornamentation.

5. The device of claim 1, wherein said device if made of a material selected from a group consisting of metal, wood, plastic, cement, and combinations thereof.

6. The device of claim 1, wherein said basin and said lip are integrally formed.

7. The device of claim 1, wherein said lip is comprised of an inner portion, an outer portion, at least one aperture, and at least one screw corresponding to one of said at least one aperture, wherein each of said at least one screw laterally translates to frictionally engage an outer surface of said wellhead.

8. The device of claim 1, wherein said device further includes a adaptation feature positioned within said reservoir of said basin.

9. The device of claim 1, wherein said device further includes at least one water depth regulators on said basin.

10. A bird bath to at least partially conceal a wellhead by temporarily securing said bird bath to said wellhead, said bird bath comprising:
a basin, said basin forming a reservoir for holding water and having a lower surface;
an adaptation feature positioned within said reservoir of said basin to reduce a depth of at least a portion of said reservoir; and
a lip extending downward from said bottom surface of said basin, said lip adapted to temporarily secure said device to a wellhead.

11. The bird bath of claim 10, wherein said basin is formed of a shape selected from a group consisting of circular, ovular, elliptical, and rectangular.

12. The bird bath of claim 10, wherein said basin further includes ornamentation.

13. The bird bath of claim 10, wherein said device if made of a material selected from a group consisting of metal, wood, plastic, cement, and combinations thereof.

14. The bird bath of claim 10, wherein said basin and said lip are integrally formed.

15. The bird bath of claim 10, wherein said lip is comprised of an inner portion, an outer portion, at least one aperture, and at least one screw corresponding to one of said at least one aperture, wherein each of said at least one screw laterally translates to frictionally engage an outer surface of said wellhead.

16. The bird bath of claim 10, wherein said device further includes at least one water depth regulator on said basin.

17. The bird bath of claim 10, wherein said device further includes at least one edge to provide a perch.

18. A device comprised of:
a basin, said basin forming a reservoir for holding water and having a lower surface;
an adaptation feature positioned within said reservoir of said basin;
at least one water depth regulator on said basin; and
a lip extending downward from said bottom surface of said basin, said lip adapted to temporarily secure said device to a wellhead, said lip comprised of an inner portion, an outer portion, at least one aperture, and at least one screw corresponding to one of said at least one aperture, wherein each of said at least one screw laterally translates to frictionally engage an outer surface of said wellhead;
wherein said device at least partly conceals said wellhead.

19. The device of claim 18, wherein said basin is formed of a shape selected from a group consisting of circular, ovular, elliptical, and rectangular.

20. The device of claim 18, wherein said basin further includes ornamentation.

21. The device of claim 18, wherein said device if made of a material selected from a group consisting of metal, wood, plastic, cement, and combinations thereof.

22. The device of claim 18, wherein said basin and said lip are integrally formed.

23. The device of claim 18, wherein said device further includes at least one edge to provide a perch.
